(19) United States
(12) Patent Application Publication
(10) Pub. No.: US 2009/0066539 A1
(43) Pub. Date: Mar. 12, 2009

(54) ROAD COMMUNICATION SYSTEM AND MOBILE DEVICE

(76) Inventors: Nobuo Uemura, Tokyo (JP); Hideo Furuya, Tokyo (JP); Hideo Shimoshimano, Tokyo (JP); Jyun Tanaka, Tokyo (JP)

Correspondence Address: ERIC ROBINSON, PMB 955, 21010 SOUTHBANK ST., POTOMAC FALLS, VA, 20165, US

(21) Appl. No.: 12/294,489

(22) PCT Filed: Mar. 26, 2007
(86) PCT No.: PCT/JP2007/057325

§ 371 Date: Oct. 17, 2008

(30) Foreign Application Priority Data
Mar. 27, 2006 (JP) 2006-085887

(51) Int. Cl. G08G 1/09

(52) U.S. Cl. 340/905

(57) ABSTRACT

A mobile device (20) comprises mobile establishing means for establishing communication with a road device (40), detecting means for detecting vehicle information on a vehicle, mobile transmitting means for transmitting the detected vehicle information to the road device, mobile receiving means for receiving warning information transmitted from the road device depending on the transmitted vehicle information, and presenting means for presenting the received warning information. The road device (40) comprises road establishing means for establishing communication with the mobile device, road receiving means for receiving the vehicle information transmitted from the mobile device, acquiring means for acquiring road environment information, creating means for comparing the road environment information and the vehicle information and creating warning information as necessary, and road transmitting means for transmitting the warning information to the mobile device. Thus, a road communication system capable of reliably transmitting warning information to the driver even if the vehicle is traveling at high speed is provided.

### TECHNICAL FIELD

The present invention relates to a road communication system and a mobile device.

### BACKGROUND ART

Japanese Patent Application Laid-Open No. H6-28596 (abstract, paragraphs 0007-0017) discloses a technique of calling attention of the driver of a vehicle exceeding the speed limit to a guide notice board.

In the technique, traveling vehicles are shot at a regular time interval by a TV camera installed above a road, the vehicle registration number of a vehicle is identified while the speed is obtained from the amount of displacement of the vehicle between the shot images, and, if there is over-speeding, the fact of over-speeding is displayed on the guide notice board together with the vehicle registration number.

### DISCLOSURE OF THE INVENTION

Incidentally, in the technique described in Japanese Patent Application Laid-Open No. H6-28596, a vehicle registration number is displayed on the guide notice board in addition to the fact that there is over-speeding; however, there is a problem that it is difficult to read such information in an instant because vehicles traveling at high speed pass a readable range of the guide notice board in the shortest time. That is to say, there is a problem that it is difficult for a driver to recognize what is displayed, or to whom the warning is issued because it is difficult to understand the displayed contents in the shortest time.

Further, there is also a problem that when a plurality of vehicles are traveling, it is not always clear which vehicle the warning is for.

In consideration of the above circumstance, an object of the present invention is to provide a road communication system and a mobile device that capable reliably transmitting warning information to a driver even if the vehicle is traveling at high speed.

In order to achieve the above object, a road communication system of the present invention has a mobile device mounted on a vehicle, and a road device disposed on or near a road, wherein the mobile device has mobile establishing means for establishing communication with the road device, detecting means for detecting vehicle information as information about the vehicle, mobile transmitting means for transmitting the vehicle information detected by the detecting means to the road device, mobile receiving means for receiving warning information transmitted from the road device depending on the vehicle information transmitted by the mobile transmitting means, and presenting means for presenting warning information received by the mobile receiving means, and the road device has road establishing means for establishing communication with the mobile device, road receiving means for receiving the vehicle information transmitted from the mobile device, acquiring means for acquiring road environment information, which is information about the road environment, creating means for comparing the road environment information with the vehicle information and creating warning information as necessary, and road transmitting means for transmitting the warning information created by the creating means to the mobile device.

Further, the road communication system of the present invention has a mobile device mounted on a vehicle, and a road device disposed on or near a road, wherein the mobile device has mobile establishing means for establishing communication with the road device, detecting means for detecting vehicle information as information about the vehicle, mobile receiving means for receiving from the road device, road environment information, which is information about the vehicle information detected by the detecting means, and information about the road environment, creating means for comparing the road environment information with the vehicle information and creating warning information as necessary, and presenting means for presenting the warning information created by the creating means, and the road device has road establishing means for establishing communication with the mobile device, acquiring means for acquiring the road environment information requested by the mobile device, and road transmitting means for transmitting the road environment information acquired by the acquiring means to the mobile device.

Further, in a road communication system according to another invention, in addition to the above invention, the vehicle information is information indicating the traveling speed of a vehicle, the road environment information is information indicating the speed limit of a road on which the vehicle is traveling, and the presenting means warns of over-speeding when the traveling speed exceeds the speed limit by a predetermined amount.

Further, in a road communication system according to another invention, in addition to the above invention, the vehicle information is information indicating the traveling speed of a vehicle, the road environment information is information indicating the slope of a road on which the vehicle is traveling, and the presenting means warns to adjust the speed when the slope is outside a predetermined range, and if the traveling speed of the vehicle is not within a predetermined range.

Further, in a road communication system according to another invention, in addition to the above invention, the vehicle information is information indicating the traveling speed of a vehicle, the road environment information is information indicating the weather near a road on which the vehicle is traveling, and the presenting means warns to reduce the speed when the weather becomes weather coinciding with a predetermined condition.

Further, in a road communication system according to another invention, in addition to the above invention, the vehicle information is information indicating a turning-on state of a front illumination lamp of a vehicle, the road environment information is information indicating the weather or brightness near a road on which the vehicle is traveling, and the presenting means warns to turn on the front illumination lamp when the weather becomes weather coinciding with a predetermined condition or when the brightness reaches a predetermined brightness or lower.

Furthermore, in a road communication system according to another invention, in addition to the above invention, the presenting means displays a predetermined character or image information on a display with which vehicle mounted equipment mounted on the vehicle is equipped.

Furthermore, in a road communication system according to another invention, in addition to the above invention, the presenting means outputs predetermined audio information from a speaker with which the vehicle mounted equipment mounted on the vehicle is equipped.

Furthermore, in a road communication system according to another invention, in addition to the above invention, the mobile device further has control means for controlling a predetermined portion of the vehicle, wherein the control means controls the applicable portion of the vehicle so as to avoid a warned situation when the presenting means presents warning information.

Moreover, the mobile device of the present invention, which is mounted on the vehicle as a movable body, and communicates with the road device disposed on or near a road, has mobile establishing means for establishing communication with the road device, detecting means for detecting vehicle information as information about the vehicle, mobile transmitting means for transmitting the vehicle information detected by the detecting means to the road device, mobile receiving means for receiving the warning information transmitted from the road device depending on the vehicle information transmitted by the mobile transmitting means, and presenting means for presenting the warning information received by the mobile receiving means.

Further, the mobile device of the present invention, which is mounted on the vehicle as a movable body, and communicates with the road device disposed on or near a road, has mobile establishing means for establishing communication with the road device, detecting means for detecting vehicle information as information about the vehicle, mobile receiving means for receiving from the road device, road environment information, which is information about the vehicle information detected by the detecting means, and information about the road environment, creating means for comparing the road environment information with the vehicle information and creating warning information as necessary, and presenting means for presenting the warning information created by the creating means.

The present invention can provide a road communication system and a mobile device capable of reliably transmitting warning information to a driver even when a vehicle is traveling at high speed.

### BRIEF DESCRIPTION OF THE DRAWINGS

FIG. 1 is a block diagram showing the exemplary configuration of a road communication system according to an embodiment of the present invention;

FIG. 2 is a block diagram showing the exemplary configuration of a road device shown in FIG. 1;

FIG. 3 is a block diagram showing the exemplary configuration of a mobile device shown in FIG. 1;

FIG. 4 is a block diagram showing the exemplary configuration of vehicle mounted equipment shown in FIG. 1;

FIG. 5 is a flow illustrating the flow of communication between the road device and the mobile device shown in FIG. 1;

FIG. 6 is a diagram showing the configuration of data transmitted/received between the road device and the mobile device shown in FIG. 1, (A) indicating a downlink, and (B) indicating an uplink; and

FIG. 7 is an example of information displayed on a display of the vehicle mounted equipment shown in FIG. 1.

### BEST MODES FOR CARRYING OUT THE INVENTION

An embodiment of the present invention will now be described with reference to the drawings.

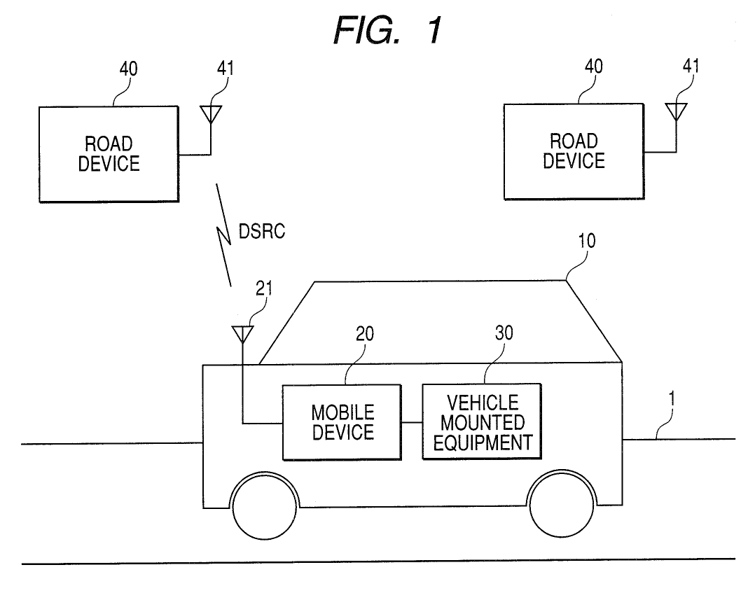

FIG. 1 is a diagram showing the exemplary configuration of a road communication system according to an embodiment of the present invention. As shown in this figure, the road communication system includes, as main components, a mobile device 20 and vehicle mounted equipment 30 mounted on a vehicle 10, and a road device 40 disposed on a road 1. Note that one road device 40 may exist, or a plurality of road devices 40 may exist.

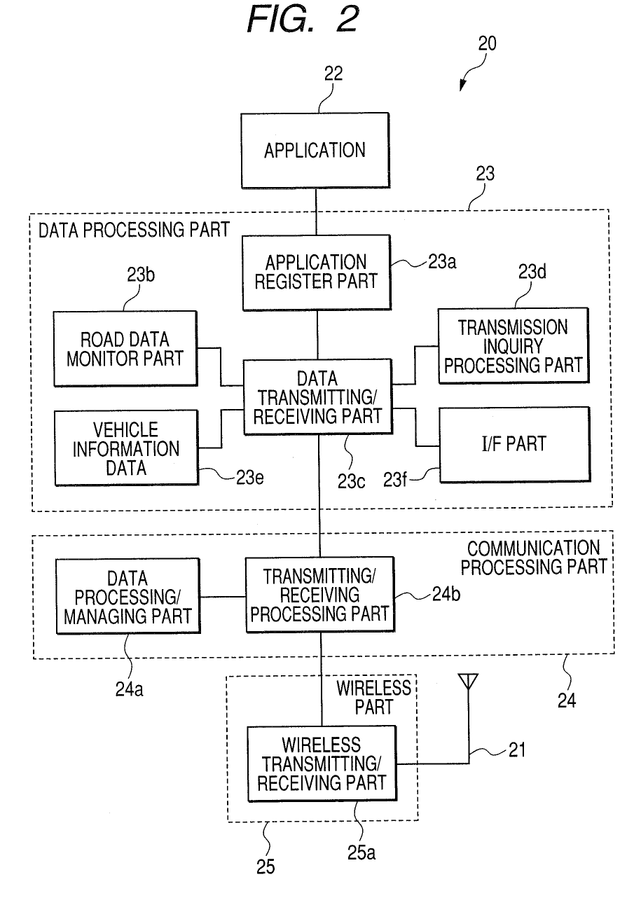

The mobile device 20 transmits/receives information to/from the road device 40 through an antenna 21 via the dedicated short range communication (DSRC). The DSRC is a communication scheme, which called dedicated short range communication, capable of one-to-one two-way communication within a range from several meters to several hundreds of meters, and used for an electronic toll collection system (ETC) or the like. Note that the mobile device 20 will be described later in detail with reference to FIG. 2.

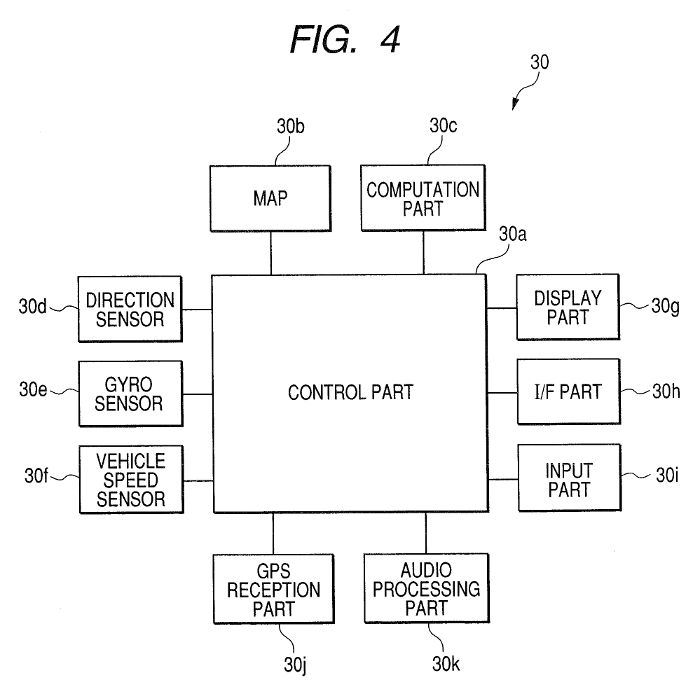

The vehicle mounted equipment 30 is an apparatus that is constituted by, for example, a navigation apparatus, detects the location of its own vehicle with a global positioning system (GPS), and leads to a destination based on geographic information stored in a hard disk drive (HDD) or a digital versatile disk (DVD). Note that the vehicle mounted equipment 30 will be described later in detail with reference to FIG. 4.

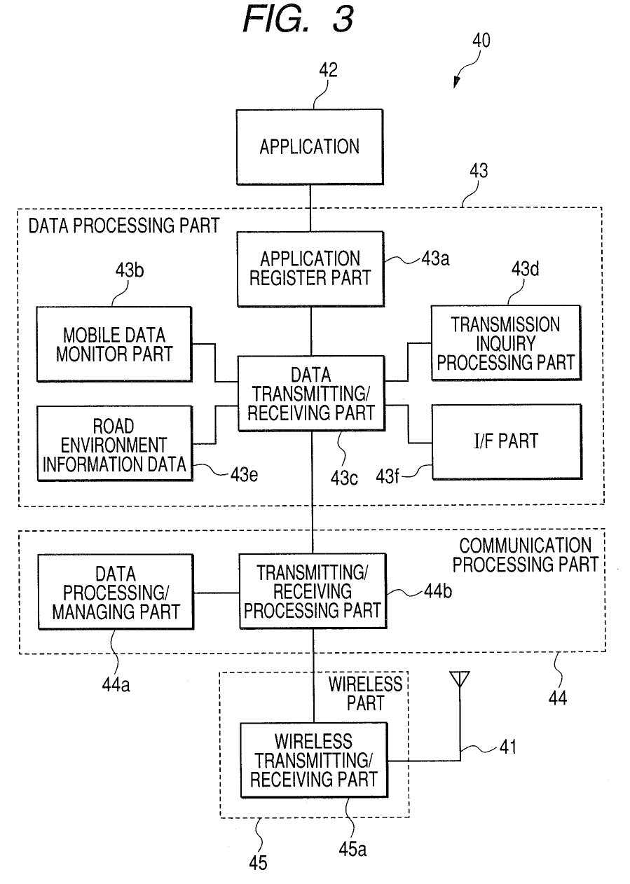

When the vehicle 10 enters into a communication area, the road device 40 establishes communication with the mobile device 20 and transmits/receives information via the DSRC. Note that the road device 40 will be described later in detail with reference to FIG. 3.

FIG. 2 is a block diagram showing the detailed exemplary configuration of the mobile device 20 shown in FIG. 1. As shown in this figure, the mobile device 20 includes, as main components, an application 22, a data processing part 23, a communication processing part 24, a wireless part 25 and an antenna 21.

The application 22 is a program that achieves, for example, transmission control protocol/internet protocol (TCP/IP) communication and activates and operates under an operating system, which is not shown. Note that the application 22 corresponds to a network layer, which performs TCP/IP communication as an upper application layer.

The data processing part 23, serving as mobile establishing means, includes, as main components, an application register part 23a, a road data monitor part 23b, data transmitting/receiving part 23c, a transmission inquiry processing part 23d, a vehicle information data 23e, and I/F part 23f, and operates as an application sub-layer (ASL) as an intermediate adaptive layer.

The application register part 23a has a function for managing or monitoring the startup, end, and running state of the application 22.

The road data monitor part 23b monitors “transmission inquiry” transmitted from the road device 40, data transmitted from the road device 40, and the protocol (e.g., TCP/IP) of the application.

The data transmitting/receiving part 23c, serving as detecting means, part of presenting means, and creating means, plays a role in transmitting/receiving IP packet data, such as file data, between the application 22 and the communication processing part 24, and controlling each part of the device.

The transmission inquiry processing part 23d creates “transmission inquiry request” used in the DSRC to add the request to block data, or allocates only created transmission inquiry request to a predetermined location of a message data slot (MDS) in a communication frame as block data. The transmission inquiry request has both a data check function for inquiring the road device 40 whether or not there is data to be transmitted, and a health check function for inquiring whether or not the mobile device 20 is in the communication area of the road device 40.

The vehicle information data 23e stores information about the vehicle 10. Note that, as vehicle information, for example, information about traveling speed of the vehicle 10, information about a turning-on state of a front illumination lamp, information about the presence or absence of a fog lamp, information about a turning-on state of the fog lamp, information about temperature of cooling water, and the like are stored. Such information is collected through the vehicle mounted equipment 30, or collected directly from a sensor disposed on the vehicle 10, or entered by a manual operation when the mobile device 20 is mounted.

The interface (I/F) part 23f, serving as part of the presenting means, is an interface that is constituted by, for example, a universal serial bus (USB), and connected with the vehicle mounted equipment 30 by a connecting cable, which is not shown, and transmits/receives information to/from the vehicle mounted equipment 30.

The communication processing part 24, serving as mobile receiving means and mobile transmitting means, is constituted by a data processing/managing part 24a and a transmitting/receiving processing part 24b, and performs DSRC processing as a lower communication layer.

The data processing/managing part 24a determines the type of the data processing part 43 of the counterpart road device 40, and monitors the occurrence of a difference in the protocol of the data processing part 43 and errors occurring during data transmitting/receiving processing.

The transmitting/receiving processing part 24b carries out slot allocation and packet organization in the communication frames of data transmitted/received to/from the road device 40.

The wireless part 25 has a wireless transmitting/receiving part 25a, and performs wireless communication with the road device 40.

The wireless transmitting/receiving part 25a modulates/demodulates signals of the communication frames to be transmitted/received with an amplitude shift keying (ASK) scheme, or a quadrature phase shift keying (QPSK) scheme, and performs wireless communication with the road device 40.

The antenna 21 emits electric waves supplied by the wireless transmitting/receiving part 25a, and captures electric waves emitted from the road device 40.

FIG. 3 is a block diagram showing the detailed exemplary configuration of the road device 40. In this figure, since a block having the same name as that of FIG. 2 has almost the same function as that of FIG. 2, the description thereof is omitted. In the example of FIG. 3, the road data monitor part 23b in FIG. 2 is replaced with a mobile data monitor part 43b. Further, I/F part 43f is communicatably connected to another road device 40. Furthermore, the vehicle information data 23e is replaced with a road environment information data 43e.

The mobile data monitor part 43b monitors “transmission inquiry” transmitted from the mobile device 20, data transmitted from the mobile device 20, and the protocol of the application.

The road environment information data 43e has information about the environment of the road on which the road device 40 is disposed. Note that, as information about the environment of the road, for example, information about the legal speed of the road, information about the present weather, information about a road slope, information about the brightness near the road, and the like are included. The road environment information data 43e is updated whenever necessary, depending on the change in such information.

The I/F part 43f is an interface that is mutually connected with other road devices 40 through a network, which is not shown, and transmits/receives information.

Note that, in the road device 40, the data processing part 43 serves as road establishing means. A data transmitting/receiving part 43c serves as acquiring means and creating means. A communication processing part 44 serves as road establishing means.

FIG. 4 is a block diagram showing the detailed exemplary configuration of the vehicle mounted equipment 30. As shown in the figure, the vehicle mounted equipment 30 includes, as main components, a control part 30a, a map data base (DB) 30b, a computation part 30c, a direction sensor 30d, a gyro sensor 30e, a vehicle speed sensor 30f, a display part 30g, an I/F 30h, an input part 30i, a GPS reception part 30j, and an audio processing part 30k.

The control part 30a is constituted by, for example, a central processor such as a central processing unit (CPU), reads and executes a program stored in a storage unit (e.g., HDD), which is not shown, to control each part of the device, and performs various types of computation processing.

The map DB 30b is stored in an HDD or a DVD, which is not shown, and comprises information showing maps in various scales, roads, and various facilities. The control part 30a identifies the location of its own vehicle by the GSP information received by the GPS reception part 30j, reads the map information of a predetermined range centered on the location from the map DB 30b, and displays it on the display part 30g. The driver refers to the information to confirm the location of the vehicle on the map.

The computation part 30c is, for example, a processor for exclusively processing mathematical computations, performs computation processing corresponding to commands supplied from the control part 30a, and supplies the obtained computation result to the control part 30a.

The direction sensor 30d is constituted by, for example, a magnetic element or the like, and can detect the direction in which the vehicle 10 oriented (or is travel direction) by detecting earth magnetism.

The gyro sensor 30e is constituted by, for example, a mechanical or oscillating sensor, detects the angular speed of a roll axis, a pitch axis, and a yaw axis, for example, and outputs corresponding data.

The vehicle speed sensor 30f is a sensor for detecting the speed of the vehicle 10, and creates a vehicle speed pulse signal having pulse density according to the vehicle speed, for example.

The display part 30g is constituted by, for example, a liquid crystal display (LCD) or the like, and displays images supplied by the control part 30a.

The I/F 30h is a USB interface, for example, and connected with the mobile device 20 by a connecting cable, and transmits/receives information to/from the mobile device 20.

The input part 30i is an operation button, a remote controller, and/or a touch panel over the display part 30g, for example, and creates and outputs information according to the operation of the driver.

The operation of the above embodiment will now be described.

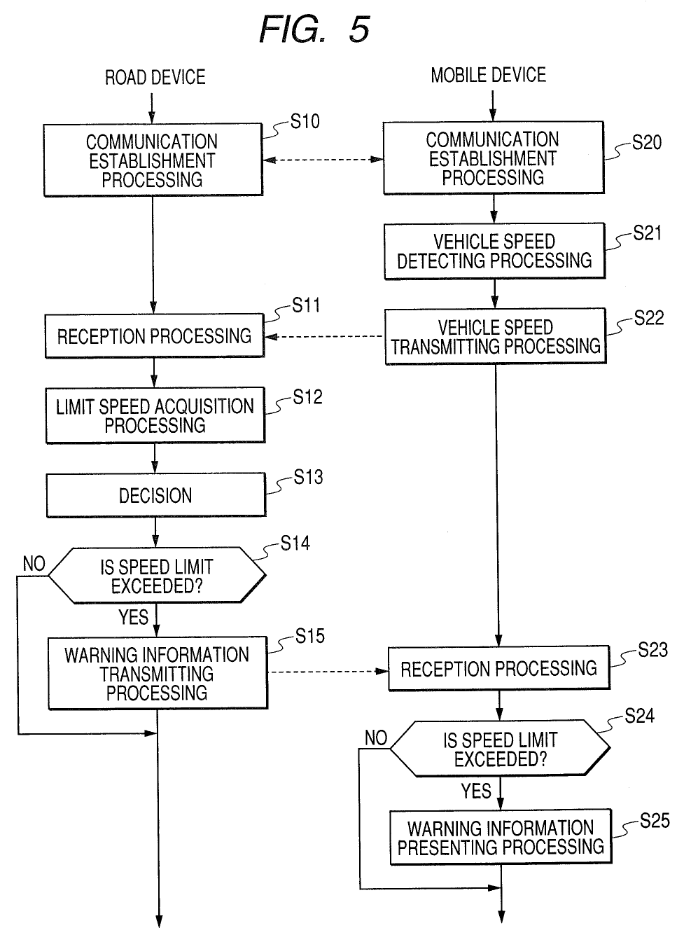

FIG. 5 is a flowchart showing the flow of communication processing between the road device 40 and the mobile device 20. While traveling on the road 1, when the vehicle 10 enters into a communication area provided by the road device 40 (e.g., a range from several meters to several hundreds of meters in radius, centered on the road device 40), communication establishment processing is executed between the two parties (steps S10 and S20), establishing the DSRC. That is to say, the road device 40 assigns the mobile device 20 to a plurality of time-divided slots of a communication frame. The road device 40 transmits a transmission inquiry message (hereinafter referred to as a transmission inquiry request) to the mobile device 20, and the mobile device 20, which received the transmission inquiry request, transmits a transmission inquiry response message (hereinafter referred to as a transmission inquiry response) to the road device 40. The transmission inquiry request from the road device 40 and the transmission inquiry response from the mobile device 20 are each performed on the same channel as a normal data transmission. At this time, the mobile device 20 can transmit/receive data only via the slot assigned to its own device, and if the data is to be transmitted from the mobile device 20 to the road device 40, this can be carried out only at the timing when a transmission inquiry request is received from the road device 40, and a transmission inquiry response is transmitted, by addition to this transmission inquiry response.

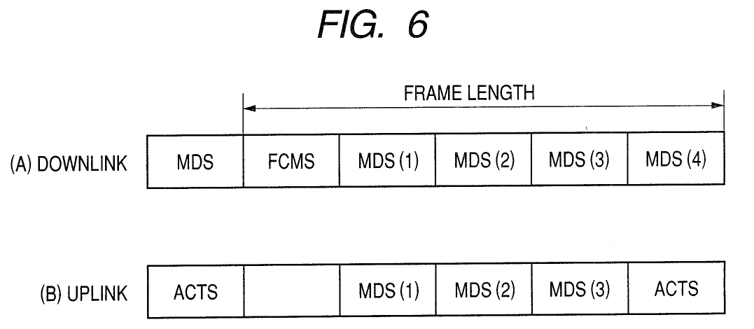

FIG. 6 is a diagram showing an example of the data configuration of information transmitted/received between the road device 40 and the mobile device 20. Note that the example of this figure shows the data configuration (slot configuration) in a STD-T55 scheme. FIG. 6(A) shows the data configuration of a downlink (in the direction from the road device 40 to the mobile device 20), and FIG. 6(B) shows the data configuration of an uplink (in the direction from the mobile device 20 to the road device 40). One frame is constituted by a frame control message slot (FCMS) for slot allocation, a message data slot (MDS) for data transfer, and an activation slot (ACTS) for link connection. The mobile device 20 has a 32-bit link address (LID) determined at startup, and makes a slot allocation request to the road device 40 in the ACTS. The road device 40 assigns the MDS to the mobile device 20, and uses the FCMS to notify which LID of mobile device 20 can use which MDS. The mobile device 20 can perform reception or transmission at assigned MDS timing. In this way, one-to-one communication is established.

As described above, when the communication of the DSRC scheme is established between the road device 40 and the mobile device 20, the mobile device 20 detects the vehicle speed based on independent judgment or the request from the road device 40 (step S21). That is to say, the transmitting/receiving part 23c makes a request to detect the vehicle speed to the vehicle mounted equipment 30 through I/F part 23f. As a result, the control part 30a of the vehicle mounted equipment 30 that received the request through the I/F part 30h acquires information about the vehicle speed outputted from the vehicle speed sensor 30f, converts it into speed information in distance per hour as necessary, and supplies the information to the mobile device 20 through the I/F part 30h. The mobile device 20 receives the information through the I/F part 23f. Note that the data transmitting/receiving part 23c of the mobile device 20 may acquire data related to the vehicle speed from the vehicle information data 23e.

The data transmitting/receiving part 23c makes a transmission inquiry request to the road device 40. The data transmitting/receiving part 43c of the road device 40 recognizes that the transmission inquiry request is made from the mobile device 20, and creates a transmission inquiry response. The data transmitting/receiving part 43c allocates the created transmission inquiry response to the assigned MDS of the communication frame. Then, the communication processing part 44 and the wireless part 45 modulate the transmission inquiry response, and transmit it to the mobile device 20 through the antenna 41. As a result, the mobile device 20 that received the transmission inquiry response stores in the assigned MDS, the vehicle speed information detected in step S21, and transmits it to the road device 40 (step S22).

The road device 40 receives information transmitted from the mobile device 20 in step S22 (step S11). That is to say, the data transmitting/receiving part 43c of the road device 40 extracts the vehicle speed information stored in the assigned MDS.

Next, the data transmitting/receiving part 43c of the road device 40 acquires speed limit information from the road environment information data 43e (step S12). Note that speed limit information includes, for example, legal speed, which is constant regardless of changes in the weather, and legal speed such as on express highway, which sets the speed to slow in case of a bad weather (e.g., heavy rain) (for example, 80 km/h for other than bad weather, and 60 km/h in case of bad weather).

The data transmitting/receiving part 43c of the road device 40 compares the vehicle speed information received in step S11 with the speed limit information acquired in step S12, and determines whether or not the vehicle 10 exceeds the speed limit (step S13). Note that if a driver is warned frequently during traveling with the speed limit slightly exceeded, this is cumbersome for the driver as concentration is lost; therefore, a predetermined threshold can be defined beforehand (e.g., 10 km/h), and over-speeding may be determined when the threshold+speed limit (e.g., threshold 10 km/h+speed limit 80 km/h=90 km/h) is exceeded. Then, when over-speeding is determined, the process goes to step S15, otherwise, the process ends (step S14). Note that determination in consideration of a threshold may be performed in step S24. That is to say, a threshold may be set by the mobile device 20. According to such a method, a warning can be issued depending on the operation level of drivers, for example.

When over-speeding is determined in step S14, the transmitting/receiving part 43c transmits warning information to the mobile device 20 (step S15). That is to say, the transmitting/receiving part 43c stores in the MDS assigned to the mobile device 20, information indicating that the speed limit is exceeded, and transmits the information to the mobile device 20.

The mobile device 20 receives electric waves transmitted from the road device 40, and acquires the warning information stored in the MDS (step S23). Then, the data transmitting/receiving part 23c refers to the received warning information, and determines whether or not the warning is about over-speeding (step S24); if the warning is about over-speeding, the process goes to step S25, otherwise, the process ends.

In step S24, when it is determined that the warning is about over-speeding, the data transmitting/receiving part 23c gives the vehicle mounted equipment 30 an instruction to display the warning information through the I/F part 23f (step S25). Note that the warning information may be included in information transmitted from the road device 40, and supplied to the vehicle mounted equipment 30 so that the vehicle mounted equipment may present the information, or several patterns may be prepared in advance in the mobile device 20 or the vehicle mounted equipment 30, and a predetermined pattern may be selected based on the warning information supplied from the road device 40.

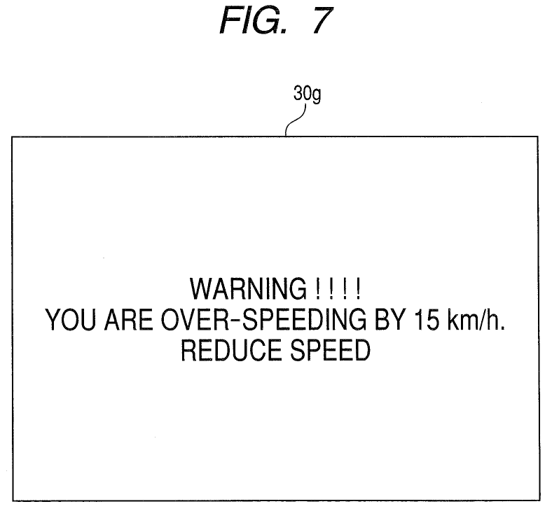

The vehicle mounted equipment 30 receives the instruction through the I/F part 30h. The control part 30a of the vehicle mounted equipment 30 causes the display part 30g to display information corresponding to the received warning information. FIG. 7 is a diagram showing an example of information displayed on the display part 30g at that time. In this example, on the display part 30g, “Warning!!!! You are over-speeding by 15 km/h. Reduce speed” is displayed as a message. At that time, warning sound may be outputted from the audio processing part 30k, or an audio message indicating over-speeding may be outputted.

Such display of a warning is presented continuously until a predetermined time elapses, or until the speed is reduced.

Note that even when the vehicle moves out of the communication area of the predetermined road device 40, the same processing is repeated between another road device 40 and the mobile device 20; therefore, the warning information is presented continuously during over-speeding. The driver is forced to reduce the speed.

According to the above embodiment, the vehicle speed is detected in the mobile device 20, transmitted to the road device 40, which in turn compares the vehicle speed with the speed limit; in the case of over-speeding, warning information is transmitted to the mobile device 20 and displayed on the display part 30g, while a warning is issued by audio or the like. Consequently, since the information can be presented near the driver, the over-speeding can be reliably informed to the driver.

In addition, since one-to-one communication is established between the road device 40 and the mobile device 20, even if a plurality of vehicles are traveling, the road device 40 can detect a vehicle that exceeds the speed limit, and issue a warning only to the vehicle. Therefore, even if a plurality of vehicles are traveling, a warning can be reliably issued to the vehicle that exceeds the speed limit. Further, the driver can be informed reliably that the warning is addressed to himself/herself.

Since the road device 40 can be miniaturized into an IC, the cost can be reduced as compared with the technique described in Japanese Patent Application Laid-Open No. H6-28596 in which a large notice board is used. Power consumption can also be reduced.

Note that although the above embodiment is a preferred example of the present invention, the present invention is not limited thereto, rather, various alterations and modifications can be made without departing from the spirit of the present invention.

For example, although, in the above embodiment, the mobile device 20 detects and transmits the vehicle speed to the road device 40, and the road device 40 compares the vehicle speed with the speed limit, and determines whether or not the speed limit is exceeded, for example, the road device 40 may acquire and transmit the speed limit to the mobile device 20, and the mobile device 20 may determine whether or not the speed limit is exceeded. In this case, the load on the road device 40 can be reduced.

Further, although, in the above embodiment, a warning indicating that the speed limit is exceeded is issued, the description of a penalty may also be displayed along with the warning. More specifically, a warning such as “You are over-speeding by 90 km. If you continue, your driver's license will be revoked” may be displayed. According to such an embodiment, the description of the penalty becomes clear, which gives a strong warning to the driver, thus, the driver is forced to reduce the speed. Note that, when such a warning is to be issued, with a table prepared in the road device 40 or the mobile device 20, which relates the ranges of over-speeding and the descriptions of penalties, if over-speeding is determined, the table is looked-up to identify the description of the penalty, and the description of the penalty may be displayed together.

Further, when a warning is issued, if the warning information is to be outputted as sound and not only displayed as characters or image information on the display device 30g, the volume of the sound may be automatically adjusted depending on the over-speeding situation. More specifically, when the over-speeding is less than 10 km/h, for example, the sound is played with normal sound, when the over-speeding is equal to or greater than 10 km/h and less than 20 km/h, the sound is played with the volume increased by 6 dB, and when the over-speeding is equal to or greater than 30 km/h, the sound is played with the volume increased by 12 dB. Note that when a user is playing music through an on-board audio and the like, the volume of the playing may be temporarily reduced to give a warning.

Further, although, in the above embodiment, a warning is issued based on legal speed, a warning may be issued in consideration of geological formation or the like, in addition to legal speed. For example, in the case of a steeply sloping road, keeping the accelerator constant only leads to deceleration or acceleration without being able to keep a constant speed, therefore, in the case of a road with a slope that is outside a predetermined range (for example, ascent of a predetermined slope or greater, or descent of a predetermined slope or less), a warning may be issued if the vehicle speed is outside the range of the predetermined speed. More specifically, when the slope is a sharp ascent, if the vehicle speed is less than a predetermined speed, a warning such as “You are speeding down. Accelerate a little” may be issued. Further, without considering the vehicle speed, when the slope is a sharp decent, a warning such as “This is a descent. Beware of excessive speed” may be issued.

Further, a warning may be issued in consideration of the weather or the condition of the road surface, in addition to the legal speed. For example, since when it is raining, the risk of a skid is increased, when it is raining, a threshold may be set lower than usual, and a warning such as “The road surface is wet, and there is a risk of a skid. Reduce speed” may be issued. More specifically, when the road surface is dry, the threshold may be set to 15 km/h, and when it is raining or the road surface is wet, the threshold may be set to 5 km/h. Further, when it is snowing, or when the road surface is frozen, the threshold may be set to −20 km/h. In particular, since the road surface is sometimes frozen on a bridge or in the shade, detailed information can be presented to the driver by issuing a warning based on the local road surface information.

Although, in the above embodiment, a warning is issued to reduce the vehicle speed, other warnings may be issued. For example, if the road has become dark, a warning may be issued to turn on a front illumination lamp. More specifically, the road device 40 detects the surrounding brightness by a light sensor, and when it gets darker than a predetermined brightness, a warning may be issued. Further, in heavy fog, a warning may be issued to turn on the front illumination lamp or fog lamp. Note that, regarding a fog lamp, since some vehicles are equipped with a fog lamp, others are not equipped with a fog lamp, the presence or absence of a fog lamp is registered with the mobile device 20; when a fog lamp is equipped, a warning may be issued to turn it on, on the other hand, when no fog lamp is equipped, a warning may be issued to turn on a front illumination lamp. Further, when the water temperature of a radiator is increased, a warning about it may be issued. According to such a method, an accident caused by overheat of an engine can be prevented.

Further, although, in the above embodiment, a case in which one-to-one communication is established between the road device 40 and the mobile device 20 is taken as an example for purposes of illustration, in the DSRC, one road device 40 can communicate with a plurality of mobile devices 20 simultaneously. That is to say, as described above, the mobile device 20 has a 32-bit unique LID, which is determined at startup, and slot allocation is performed based on the LID; therefore, even if a plurality of vehicles enter into the communication area of one road device 40 simultaneously, the road device 40 can determine which vehicle. Thus, an appropriate warning can be issued to each vehicle.

Further, in the DSRC, even when a vehicle gets out of the communication area of the predetermined road device 40, the communication can continue with the next road device 40 by performing hangover processing. In this case, since continuous communication is performed between a device above the road device 40 (e.g., server apparatus) and the mobile device 20, and the operation state of the vehicle can be managed, for example, when continuous operation for a predetermined period of time or longer with a predetermined speed or faster is detected, a warning such as “Three hours are about to elapse since you started driving. Would you like to have a rest?” may be issued.

Further, a plurality of road devices 40 communicate with one another to share information, thus a warning can be issued before a vehicle comes close to a predetermined point. For example, when the road device 40 located at a point prone to freezing, such as a bridge, detects a freezing of the road surface, notifying in advance the road device 40 located before of the information, will allow a warning such as “The bridge beyond this place is frozen. Reduce speed, and pay attention to brake operation” to be issued.

Further, if vehicles can exchange information with each other through the road device 40 or a group of road devices 40, for example, when brakes are applied in a vehicle traveling ahead, the vehicles traveling behind can be issued a warning such as “Preceding vehicle braked. Be careful”.

Further, although, in the above embodiment, only a warning is issued, the mobile device 20 may work with a control device of the vehicle 10, which is not shown, to automatically control the vehicle 10, in addition to issuing a warning. For example, in the case of over-speeding, a control signal may be transmitted to an electronic fuel injection system (EFIS) serving as control means, which controls the supply of fuel to an engine, and the amount of fuel supplied to the engine may be temporarily reduced to force the speed of the vehicle 10 to be reduced to near the legal speed. Further, the speed of the vehicle 10 may be reduced to near the legal speed, not by controlling electronically, but by adjusting the throttle opening with an actuator. Note that when such a forced speed reduction is performed, for example, if there is a following vehicle, the distance between the vehicles becomes insufficient due to the speed reduction, which may cause a danger, therefore, when there is a following vehicle, the speed reduction may be halted, or the percentage of the speed reduction may be reduced. More specifically, when the following vehicle is separated by 100 m or greater, for example, the speed may be reduced at a rate of 5 km/h per unit of time (second) to near the legal speed, and if separated by 50 m or greater but less than 100 m, the speed may be reduced at a rate of 2.5 km/h per unit of time. Note that, regarding the control of speed reduction, for example, when an accident occurs, a warning is issued to all the vehicles regardless of legal speed so as to reduce vehicle speed, thus preventing a secondary accident. For example, when a multiple collision accident or fire in a tunnel occurs, even vehicles observing the legal speed may be forced to reduce the speed or stop before the accident site.

Further, in addition to reduction in the speed, for example, by coupling with the brightness of the road as described earlier, when the brightness of the road becomes less than a predetermined brightness, a control unit (not shown) serving as control means may automatically turn on the front illumination lamps, or when fog appears and visibility deteriorates, similarly, the control unit serving as control means may automatically turn on the fog lamps. According to such a method, convenience to a driver can be improved.

Further, although, in the above embodiment, the mobile device 20 and the vehicle mounted equipment 30 are formed separately, they may be provided in the same enclosure. That is to say, the mobile device 20 may be provided in a navigation apparatus, which is the vehicle mounted equipment 30.

Further, although, in the above embodiment, the mobile device 20 acquires information about the vehicle speed from the vehicle mounted equipment 30, such information may be directly acquired without involving the vehicle mounted equipment 30.

### INDUSTRIAL APPLICABILITY

The present inventions may be used for communication between a vehicle and a road, for example.

1. A road communication system comprising a mobile device mounted on a vehicle and a road device disposed on or near a road, wherein the mobile device comprises:
a mobile establishing unit adapted to establish communication with the road device;
a detecting unit adapted to detect vehicle information as information about the vehicle;
a mobile transmitting unit adapted to transmit the vehicle information detected by the detecting unit to the road device;
a mobile receiving unit adapted to receive warning information transmitted from the road device depending on the vehicle information transmitted by the mobile transmitting unit; and
a presenting unit adapted to present warning information received by the mobile receiving unit, and
the road device comprises:
a road establishing unit adapted to establish communication with the mobile device;
a road receiving unit adapted to receive the vehicle information transmitted from the mobile device;
an acquiring unit adapted to acquire road environment information, which is information about the road environment;
a creating unit adapted to compare the road environment information with the vehicle information and creating warning information as necessary; and
a road transmitting unit adapted to transmit the warning information created by the creating unit to the mobile device.

2. A road communication system comprising a mobile device mounted on a vehicle and a road device disposed on or near a road, wherein the mobile device comprises:
a mobile establishing unit adapted to establish communication with the road device;
a detecting unit adapted to detect vehicle information as information about the vehicle;
a mobile receiving unit adapted to receive from the road device, road environment information, which is information about the vehicle information detected by the detecting unit, and information about the road environment;
a creating unit adapted to compare the road environment information with the vehicle information and creating warning information as necessary; and
a presenting unit adapted to present the warning information created by the creating unit, and
the road device comprises:
a road establishing unit adapted to establish communication with the mobile device;
an acquiring unit adapted to acquire the road environment information requested by the mobile device; and
a road transmitting unit adapted to transmit the road environment information acquired by the acquiring unit to the mobile device.

3. The road communication system according to claim 1, wherein
the vehicle information is information indicating the traveling speed of the vehicle,
the road environment information is information indicating the speed limit of a road on which the vehicle is traveling, and
the presenting unit warns of over-speeding when the traveling speed exceeds the speed limit by a predetermined amount.

4. The road communication system according to claim 1, wherein
the vehicle information is information indicating the traveling speed of the vehicle,
the road environment information is information indicating the slope of a road on which the vehicle is traveling, and
the presenting unit warns to adjust the speed when the slope is outside a predetermined range, and if the traveling speed of the vehicle is not within a predetermined range.

5. The road communication system according to claim 1, wherein
the vehicle information is information indicating the traveling speed of the vehicle,
the road environment information is information indicating the weather near a road on which the vehicle is traveling, and
the presenting unit warns to reduce the speed when the weather becomes weather coinciding with a predetermined condition.

6. The road communication system according to claim 1, wherein
the vehicle information is information indicating a turning-on state of a front illumination lamp of the vehicle,
the road environment information is information indicating the weather or brightness near a road on which the vehicle is traveling, and
the presenting unit warns to turn on the front illumination lamp when the weather becomes weather coinciding with a predetermined condition or when the brightness reaches a predetermined brightness or lower.

7. The road communication system according to claim 1, wherein the presenting unit displays a predetermined character or image information on a display with which vehicle mounted equipment mounted on the vehicle is equipped.

8. The road communication system according to claim 1, wherein the presenting unit outputs predetermined audio information from a speaker with which the vehicle mounted equipment mounted on the vehicle is equipped.

9. The road communication system according to claim 1, wherein
the mobile device further comprises control unit for controlling a predetermined portion of a vehicle, wherein
the control unit controls the applicable portion of the vehicle so as to avoid a warned situation when the presenting unit presents warning information.

10. A mobile device mounted on a vehicle as a movable body, and communicating with a road device disposed on or near a road, the mobile device comprising:
a mobile establishing unit adapted to establish communication with the road device;
a detecting unit adapted to detect vehicle information as information about the vehicle;
a mobile transmitting unit adapted to transmit the vehicle information detected by the detecting unit to the road device;
a mobile receiving unit adapted to receive warning information transmitted from the road device depending on the vehicle information transmitted by the mobile transmitting unit and
a presenting unit adapted to present the warning information received by the mobile receiving unit.

11. A mobile device mounted on a vehicle as a movable body, and communicating with a road device disposed on or near a road, the mobile device comprising:
a mobile establishing unit adapted to establish communication with the road device;
a detecting unit adapted to detect vehicle information as information about the vehicle;
a mobile receiving unit adapted to receive from the road device, road environment information, which is information about the vehicle information detected by the detecting unit, and information about the road environment;
a creating unit adapted to compare the road environment information with the vehicle information and creating warning information as necessary; and
a presenting unit adapted to present the warning information created by the creating unit.
